(19) United States
(12) Patent Application Publication
(10) Pub. No.: US 2021/0386243 A1
(43) Pub. Date: Dec. 16, 2021

(54) Extendable Barbecue

(71) Applicant: ONLYDETAILS, S.L., Marbella Malaga (ES)

(72) Inventors: Olivier Joel Midy, Benahavis Malaga (ES); Christophe Midy, Mondelange (FR)

(73) Assignee: ONLYDETAILS, S.L., Marbella Malaga (ES)

(21) Appl. No.: 17/047,266

(22) PCT Filed: Jan. 3, 2019
(86) PCT No.: PCT/EP2019/050104

§ 371 Date: Oct. 13, 2020

(30) Foreign Application Priority Data
Jan. 12, 2018 (LU) LU100675
Dec. 14, 2018 (LU) LU101052

(51) Int. Cl. A47J 37/07

(52) U.S. Cl. CPC A47J 37/0768

(57) ABSTRACT

The invention is directed to a disposable or reusable barbecue (202) comprising a tray (204) forming a cavity for containing a fuel unit (205) like charcoal, a cooking grate (208) and a stand (206) for operatively holding the tray (204) and the cooking grate (208; 308) relative to each other; wherein the tray (204) is rectangular and comprises two parallel lateral shoulder edges (216); and the stand (206) comprises lower support surfaces (206.3) for said lateral shoulder edges (216), the support surfaces being configured for allowing the tray to be slid along said surfaces, and upper support surfaces (206.6) for the cooking grate (208)

### TECHNICAL FIELD

The invention is directed to the field of barbecues and to the field of metallic tray that can be used for barbecues, in particular for disposable and also reusable barbecues.

### BACKGROUND ART

Prior art patent document published CN 201743521 U discloses a tray made of aluminium foil for a disposable barbecue. The tray comprises a bottom wall and side walls forming a cavity for receiving charcoal. The side walls comprise side edges that form a horizontal annular support surface for receiving a cooking grate. The depth of the cavity is however limited so that the pieces of meat placed on the cooking grate disposed on the tray will be very close to the heat source and therefore are likely to burn. In addition, the tray is rather bulky and subject to deformations during transport.

Prior art patent document published WO 2011/072413 A1 discloses a portable and disposable barbecue comprising a tray with an integrated cooking grid and a stand. The latter comprises two U-shaped portions and a retaining elongate member that interconnects said portions so as to prevent them from moving one from each other. The stand, although simple and cheap to manufacture, is complex in use due to the three elements to be assembled properly. Similarly to the preceding document, the tray is rather bulky and subject to deformations during transport.

Prior art patent document published CN 106724919 A discloses a portable multi-functional barbecue device, which comprises a pull-out furnace body including an outer shell body, a middle furnace body slidable in the outer shell body, and an inner furnace body slidable in the middle furnace body. Transport wheel and legs are provided for holding horizontally and distant from the ground at a convenient working height the barbecue device in an extended configuration. This device is however heavy and not disposable. It is also expensive to manufacture with regard to the sliding movements of the different furnace bodies relative to each other.

Prior art patent document published US 2016/0029841 A1 discloses a barbecue with an adjustable cooking grate. It comprises essentially a stake to be inserted in the ground, a tray slidably mounted on the stake and a cooking grate also slidably mounted on the stake. This allows adjusting in height the tray and the grate. This assembly requires however a soft ground into which the stake can be inserted. It cannot therefore be placed on a table or a flat hard surface. The tray shows also a reduced depth, leading to potential firing difficulties in winding conditions. Also, the off-axis position of both the tray and the cooking grate renders the barbecue unstable.

Generally speaking, disposable barbecues form a cavity with a limited depth and in addition, the charcoal or fuel material is usually already located in the tray, the cooking grate being fixed to the tray. The charcoal is often provided with petroleum products for facilitating combustion in such a reduced space. The use of such products can be harmful and is not environment friendly.

### SUMMARY OF INVENTION

### Technical Problem

The invention has for technical problem to overcome at least one of the drawbacks of the above cited prior art. More specifically, the invention has for technical problem to provide a barbecue that provides a natural combustion with natural fuel material like charcoal, that is easy to transport, provide good roasting capabilities without burning the food, and/or easy to use.

### Technical Solution

The invention is directed to a barbecue comprising a tray forming a cavity for containing a fuel unit like charcoal, a cooking grate and a stand for operatively holding the tray and the cooking grate relative to each other; characterized in that the tray is rectangular and comprises two parallel lateral shoulder edges; and the stand comprises lower support surfaces for said lateral shoulder edges, the support surfaces being configured for allowing the tray to be slid along said surfaces, and upper support surfaces for the cooking grate.

According to a preferred embodiment, the cooking grate and/or the upper support surfaces are configured for providing a variable position in height of said grate.

According to a preferred embodiment, the stand is exclusively made of steel wires attached to each other so as to form a tri-dimensional structure.

According to a preferred embodiment, the two lower support surfaces are made of two parallel streel wires.

According to a preferred embodiment, each of the two parallel streel wires comprises a central main portion that is raised relative to two lateral end portions.

According to a preferred embodiment, the two parallel lateral shoulder edges form two elongate flanges that can be folded by hand around the two parallel streel wires once said tray is slid in position along said wires.

According to a preferred embodiment, the stand comprises a central passage through which a cuboid fuel unit can be placed while the cooking grate rests on a top of said unit.

According to a preferred embodiment, the cooking grate comprises a main portion forming the grate and at least two guiding elements extending perpendicularly to the main portion and configured for cooperating with the stand and guiding the cooking grate from a raised position to a lower position where said grate rests on the upper support surfaces of the stand.

According to a preferred embodiment, each of the at least two guiding elements is configured for engaging with the stand when the cooking grate is in the raised position so as to prevent removal thereof.

According to a preferred embodiment, each of the at least two guiding elements comprises two parallel steel wire terminating with rounded portions and distal ends that contact each other so as to form a distal converging profile that can engage with a corresponding anchoring wire portion of the stand by pressing the cooking grate downwardly.

According to a preferred embodiment, the upper support surfaces of the stand are formed by steel wires joined perpendicularly to the anchoring wire portions.

According to a preferred embodiment, the cooking grate further comprises U-shaped steel wires extending form each side edge of the main portion, perpendicularly to said portion, so as to form lateral retaining surfaces relative to the cuboid fuel unit.

According to a preferred embodiment, the upper support surfaces of the stand provide several discrete positions in height for the cooking grate.

According to a preferred embodiment, the stand comprises a central frame, two side walls with the upper support surfaces, and at least two legs, said side walls and legs being foldable relative to the central frame.

According to a preferred embodiment, the tray comprises a bottom wall with elements forming a raised support surface for the fuel unit, configured for allowing an air circulation between said unit and said bottom wall.

According to a preferred embodiment, the elements of the bottom wall comprise at least two stiffening ribs extending parallel to each other and projecting towards an opening of the cavity.

The invention can also be directed to a barbecue comprising a tray with a bottom wall and side walls so as to form a cavity for containing charcoal, wherein the bottom wall comprises element(s) forming a raised support surface for the fuel unit, configured for allowing an air circulation between said unit and said bottom wall.

Advantageously, the elements forming the raised support surface are formed by local deformations of the bottom wall so as to form projections in the cavity oriented towards the opening of the cavity.

Advantageously, the elements forming the raised support surface comprise at least two stiffening ribs preferably extending parallel to each other.

Advantageously, the distance between the raised support surface for the fuel unit and the bottom wall is greater than 5 mm and/or less than 20 mm.

Advantageously, the side walls comprise distal edges forming a support surface for a cooking grate.

Advantageously, the support surface for the cooking grate is such that the grate can be disposed on said surface after having set fire to the burning material, e.g. the charcoal and/or wood, meaning that the grate is not initially attached to the tray. The cooking grate can be made of two parts, each forming about one half of said grate.

Advantageously, the tray comprises two parts, each with a U-shaped cross-section, said parts cooperating with each other so that the U-shaped cross-sections mate with each other and are slidable one relative to the other so as to vary the cavity in an extension direction from a collapsed state to an extended state

Advantageously, the side walls of the tray comprise lateral side walls forming the slidable U-shaped cross-sections, the distal edges of said lateral side walls comprising rail-shaped end portions of said walls that engage one inside the other with regard to the two parts.

Advantageously, the U-shaped cross-section of a first one of the two parts contacts an inner side of the U-shaped cross-section of the second one of the two parts, the rail-shaped ends portions of the lateral side walls of the first part engaging inside the rail-shaped end portions of the lateral side walls of the second part.

Advantageously, the rail-shaped end portions of the lateral side walls are rolled end portions with a generally circular cross-section.

Advantageously, the rail-shaped end portions of the lateral side walls are bent portions with a rectangular cross-section.

Advantageously, the rectangular cross-section of the rail-shaped end portions of the lateral side walls forms a cavity with an opening that is oriented transversally towards the centre of the tray, so as to receive the cooking grate by a sliding movement thereof along the longitudinal direction.

Advantageously, the cross-section of the rail-shaped end portions of the lateral side walls comprises, successively, a first horizontal section adjacent the lateral side wall, a first vertical section, a second horizontal section and a second vertical section with a distal end distant from the first horizontal section so as to form the opening of the cavity.

Advantageously, the rail-shaped end portions of the lateral side walls of a first one of the two parts that contacts an inner side of the U-shaped cross-section of the second one of said two parts comprise means for retaining the cooking grate once inserted by the sliding movement while permitting said insertion.

Advantageously, the retaining means comprise at least one tab integrally formed in at least one, preferably each, of the rail-shaped end portions of the lateral side walls, said at least one tab being configured for cooperating with transversal wires of the cooking grate.

Advantageously, the at least one tab is integrally formed in the first horizontal section the cross-section of the rail-shaped end portions.

Advantageously, the side walls comprise end side walls, the distal edge of one of said end side walls being aligned with the supporting surface so as to form a passage for inserting the cooking grate in the cavities of the rail-shaped end portions of the lateral side walls, preferably said distal edge being manually bendable so as to prevent an exit movement of said cooking grate.

Advantageously, the end side wall with the distal edge forming the passage for inserting the cooking grate is on a first one of the two parts of the tray that contacts an inner side of the U-shaped cross-section of the second one of said two parts.

Advantageously, the distal edge of the end side wall of the second part forms a rail-shaped end portion with a cavity for receiving the cooking grate, said portion comprising means for retaining the cooking grate once inserted by the sliding movement while permitting said insertion.

Advantageously, the retaining means of rail-shaped end portion of the end side wall of the second part comprise a tab that is integrally formed in the cooking plate support surface of the rail-shaped end portion.

Advantageously, the barbecue comprises means for limiting a sliding extension movement between the two parts to the extended state, so as to avoid separation of said parts.

Advantageously, the extension limiting means comprise at least one slot formed in at least one of the walls forming the U-shaped cross-section of a first one of the two parts and at least one bossing formed on a corresponding wall forming the U-shaped cross-section of the second one of the two parts and engaging in said at least one slot.

Advantageously, the at least one slot and the at least one bossing are formed in at least one, preferably each, of the lateral side walls forming the slidable U-shaped cross-sections of the trays, respectively.

Advantageously, the at least one slot and the at least one bossing are adjacent to the distal edges of the side walls.

Advantageously, the at least bossing is formed integrally with the wall where said bossing is formed.

Advantageously, the at least bossing is a pin.

Advantageously, the at least bossing shows a height that allows an engagement of said bossing into the corresponding slot(s) by elastically deforming the wall(s) where said slot(s) is/are formed.

Advantageously, the stiffening ribs extend along the extension direction of the tray.

Advantageously, the barbecue further comprises a stand for supporting the tray.

Advantageously, the stand comprises at least one support portion for receiving a bottom and/or shoulder portions of the lateral side walls of the tray and legs extending from the at least one support portion, said portion comprising at least two pins protruding towards the tray, said bottom and/or said shoulders comprising at least one opening on each one of the two parts of the tray, for receiving said pins, respectively, so as to form the means for limiting a sliding extension movement between the two parts.

Advantageously, the stand is formed of steel wires with four vertical wires distant from each other and at least two horizontal wires interconnecting the vertical wires.

Advantageously, the pins are formed by end portions of at least two of the vertical wires.

Advantageously, the four vertical wires are arranged so as to form a rectangle and the at least two horizontal wires comprise two lower parallel wires in a lower horizontal plane, for receiving the bottom of the tray, and two higher parallel wires in a higher horizontal plane, for receiving the shoulder portions of the lateral side walls of the tray.

Advantageously, the stand shows a shape such that the tray in the collapsed state fits in said stand preferably within the four vertical wires, more preferably when the stand is rotated by 90° relative to a position where said stand supports the tray in the extended state.

Advantageously, the distal edge of each side walls comprises a portion protruding from the support surface of the cooking grate, so as to surround said grate when placed on said surface.

Advantageously, the rolled end portions of the edges of the lateral side walls form the portions protruding from the support surface.

Advantageously, the tray is made of metallic foil, like aluminium and/or carbon steel, preferably with a thickness of less than 0.5 mm, preferably less than 0.2 mm, more preferably less than 0.1 mm.

Advantageously, each of the two parts of the tray is integrally formed from a metallic foil, preferably by embossing.

The raised support surface for the fuel unit enable air circulation between said unit and said bottom wall and thereby a proper combustion, more specifically a proper chimney draft when said unit is provided with a chimney.

The above invention is particularly interesting in that it provides a tray that is compact in the collapsed state while providing a larger cavity and cooking surface in the extended state. Thanks to its compact design in the collapsed state, the tray can be designed with higher side walls, thereby providing a larger distance between the bottom wall and the cooking grate. Indeed, in most commercially available barbecues, the height of the side walls is limited, e.g. less than 50 mm or even less than 40 mm, thereby provide a limited distance between the cooking grate and the bottom of the cavity. Disposable barbecues are primarily intended to be transported and should therefore be as compact as possible. The same applies also to reusable barbecues, however to a lesser extent. The invention achieves a more compact barbecue for a given cooking surface or provides a larger cooking cavity volume for a given compactness. In addition, the guiding means on the parts of the tray, ensuring the sliding movement between said parts, provide an increased rigidity to the tray which is advantageously made of a thin metallic foil. The stand is also interesting in that, by means of the pins engaging in the corresponding openings in the bottom walls, it, on one side, provides a stable support for the tray, and, on the other side, fixes the parts of the tray relative to each other.

Also, the means for retaining the cooking grate are particularly interesting for they said grate to be initially away from the tray, allowing the lighting of a voluminous and advantageous charcoal unit that is higher than the tray, and thereafter placing the cooking grate in a secure manner, i.e. that does not allow removal therefore. The latter is mandatory per regulation on disposable barbecues to be commercialized on certain markets.

The invention can also be directed to a barbecue comprising a tray with a bottom wall and side walls so as to form a cavity for containing charcoal, the side walls comprising distal edges forming a support surface for a cooking grate; wherein the distal edges of at least two opposed side walls of the side walls are rail-shaped with an opening oriented transversally towards the centre of the tray, so as to receive an edge of the cooking grate by a sliding movement thereof along said distal edges.

Advantageously, the rail-shaped distal edges comprise means for retaining the cooking grate once inserted by the sliding movement while permitting said insertion.

Advantageously, the retaining means comprise at least one tab integrally formed in at least one, preferably each of the rail-shaped distal edges, said at least one tab being configured for cooperating with transversal wires of the cooking grate.

Advantageously, the at least one tab is integrally formed in the cooking grate support surface of the rail-shaped distal edges.

Advantageously, the tray shows a single shape, preferably is made of a single piece.

Advantageously, the tray is generally rectangular with four side walls, the distal edge of one of the side walls extending between the two opposed side walls is rail-shaped with an opening oriented transversally towards the centre of the tray, so as to receive an edge of the cooking grate.

Advantageously, the barbecue further comprises a stand for supporting the tray, said stand being made of steel wires with a base frame for contacting a support surface, a receiving frame for receiving the tray and wires interconnecting said frames.

Advantageously, the side walls of the tray widen from the bottom wall to the opening of the cavity, the base frame being larger than the receiving frame such that said stand, when rotated upside down, encircles and matches said side walls.

Advantageously, the bottom wall of the tray comprises at least one, preferably two stiffening ribs.

Advantageously, the tray is made of metallic foil, like aluminium and/or carbon steel, preferably with a thickness of less than 0.5 mm, preferably less than 0.2 mm, more preferably less than 0.1 mm.

### Advantages of the Invention

The invention is interesting in that it allows the barbecue to be placed on a table or any kind of stable horizontal surface without damaging it, essentially because the tray is held above said surface by the stand. The invention is particularly designed for using cuboid fuel units, e.g. with a chimney made of cardboard and containing charcoal, preferably natural charcoal, and fire starter material like cardboard or the like. Such a unit progressively collapses as it burns, i.e. features a height that progressively diminished from start of the fire until the cardboard material has burnt the remaining material being charcoal embers.

### BRIEF DESCRIPTION OF THE DRAWINGS

FIG. 1 is a perspective view of a barbecue according to an example not being part of the invention.

FIG. 2 is another perspective view of the barbecue of FIG. 1.

FIG. 3 is perspective cross-sectional view of a lateral side wall of the barbecue of FIGS. 1 and 2.

FIG. 4 is a top view of the barbecue of FIGS. 1 to 3.

FIG. 5 is a detailed view of means for retaining the cooking grate.

FIG. 6 is a detailed view of another means for retaining the cooking grate.

FIG. 7 is a side view of the barbecue of FIGS. 1 to 6.

FIG. 8 is a front view of the barbecue of FIGS. 1 to 7.

FIG. 9 is a perspective view of the barbecue of FIGS. 1 to 8 in a collapsed and packaged state.

FIG. 10 is another perspective view of the barbecue of FIG. 9.

FIG. 11 is top perspective view of a barbecue according to another example not being part of the invention.

FIG. 12 is a perspective side view of the barbecue of FIG. 11.

FIG. 13 is a top perspective view of the barbecue of FIGS. 11 and 12, in a packaged state.

FIG. 14 is another perspective view of the barbecue of FIG. 13.

FIG. 15 is a perspective view of a tray of a barbecue according to a first embodiment of the invention.

FIG. 16 is a perspective view of a stand of the barbecue according to a first embodiment of the invention.

FIG. 17 is a top view of the stand of FIG. 16.

FIG. 18 is a perspective view of a cooking grate of the barbecue according to a first embodiment of the invention.

FIG. 19 is a perspective view of the barbecue according to a first embodiment of the invention.

FIG. 20 is a perspective view of a barbecue according to a second embodiment of the invention

### DESCRIPTION OF AN EMBODIMENT

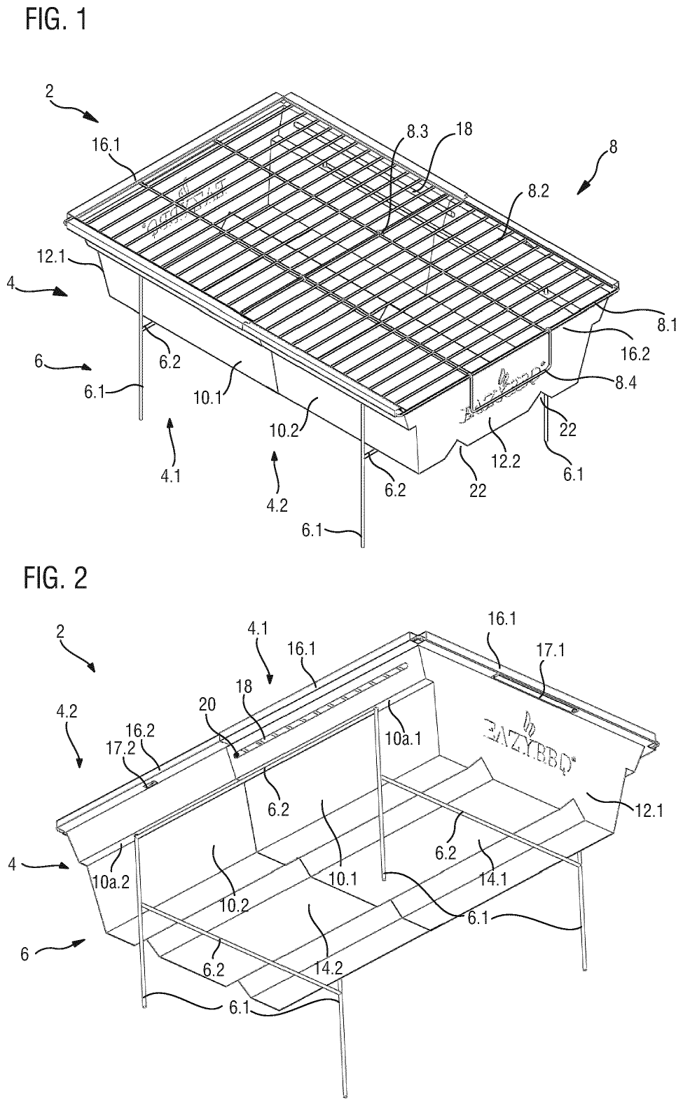

FIGS. 1 and 2 are two different perspective views of a barbecue according to an example not being part of the invention. FIG. 2 shows the barbecue of FIG. 1 from below whereas the barbecue is rotated by about 180°. The barbecue 2 comprises essentially a tray 4, a stand 6 and a cooking grate.

The tray 4 is made of metallic foil, preferably of aluminium foil. The foil can have a thickness of less than 0.5 mm, preferably less than 0.2 mm, more preferably less than 0.1 mm. As is apparent in FIG. 1, the tray 4 comprises a bottom wall and side walls forming a cavity for receiving charcoal or wood or any other combustible material that is adapted for cooking food. The tray shows advantageously a generally rectangular form where the side walls need not be perpendicular to the bottom wall, i.e. can slightly widen from the bottom to the opening of the cavity.

The tray 4 is made of two parts 4.1 and 4.2 slidable relative to each other along an extension direction. This direction corresponds to the main longitudinal direction of the tray. The two parts advantageously form two halves of the tray 4. Each part 4.1 and 4.2 shows a U-shaped cross section formed by the bottom wall 14.1 and 14.2, and by two side opposite lateral side walls 10.1 and 10.2, respectively. Each part 4.1 and 4.2 comprises also an end side wall 12.1 and 12.2. The U-shaped cross sections of the two parts 4.1 and 4.2 mate with each other, i.e. the external face of one of these two sections contacts the inner face of the other one of these sections. For instance, as is visible in FIGS. 1 and 2, the U-shaped cross section of the part 4.2 contacts the inner face of the U-shaped cross section of the part 4.1.

The side walls 10.1, 10.2, 12.1 and 12.2 comprise distal edges 16.1 and 16.2, i.e. edges that a distant from the bottom wall 14.1 and 14.2, that form a support surface for receiving the cooking grate 8. More specifically, that surface is generally planar and shows a rectangular profile. Even more specifically, the distal edges 16.1 and 16.2 can also comprise a raised portion protruding away from an external edge of the support surface so as to surround or circumvent the cooking grate, for centering purposes, when said grate is placed on said support surface. These raised or protruding portions are formed by bent end sections of the foil forming the side walls 10.1, 10.2, 12.1 and 12.2. These bent end sections provide a stiffening effect of the side walls and therefore of the whole tray 4.

The cooking grate 8 can comprise a wire contour 8.1 and transversal wires 8.2 attached thereto. The grid can be made of two parts of about the same size and hinged to each other so as to be foldable. The hinge can be formed by several, for instance two, rings 8.3 encircling the adjacent contour portions of the two parts. The grate 8 can also comprise a handle 8.4 mounted pivoting to an external portion of the contour 8.1

The bent end sections of the distal edges 16.1 and 16.2 of the lateral side walls 10.1 and 10.2 are railed shaped such that, on each lateral side of the tray, the rail-shaped end portions of the part 4.2 slidably engages inside the rail-shaped end portions of the part 4.1, so that the part 4.2 is guided relative to the part 4.1 along the sliding stroke between said parts 4.1 and 4.2. The relative sliding movement between the two parts 4.1 and 4.2 can be limited, i.e. in particular in a direction of extension of the tray, by extension limiting means. Such means can for instance be formed by a slot 18 formed on at least one lateral side wall 10.1 or 10.2 of one of the parts 4.1 and 4.2, and by a bossing 20 on the corresponding lateral side wall of the other part where said bossing 20 engages in said slot 18. For instance, the bossing 20 can be a pin and can be formed integrally with the side wall, e.g. by embossing. The bossing 20 can be formed as a pin with a limited height so that both parts 4.1 and 4.2 of the tray can be engaged with each other by elastically deforming the side wall(s) with the bossing(s) 20 and/or the side wall(s) with the slot(s).

In FIGS. 1 and 2, the tray 4 is illustrated in an extended configuration, i.e. where the pins 20 contact the ends of the slots 18, thereby preventing a further extension of the tray. The slots 18 can extend over more than 80% of the longitudinal length of the side walls 10.1 so as to allow a maximum collapsed state of the tray, i.e. where the part 4.2 is slid towards the other part 4.1 up to a point where the front faces of the lateral walls 10.2 of said part 4.2 are adjacent or even touch the end wall 12.1 of the other part 4.1.

In FIG. 2, we can observe that the distal edge 16.2 of the lateral side wall 10.2 of the part 4.2 of the tray 4 shows a tab 17.2 preferably formed integrally in the support surface for the cooking grate. The tab 17.2 is oriented so as to bend away when the cooking grate is inserted toward the end side wall 12.1 of the part 4.1 and to retain said grate against retraction once inserted. We can also observe that the distal edge 16.1 of the end side wall 12.1 of the part 4.1 can also comprise a tab 17.1 also preferably formed integrally in the support surface for the cooking grate. The tab 17.1 is oriented so as to bend back towards the support surface when the cooking grate is inserted toward the end side wall 12.1 and to retain said grate against retraction once inserted.

Still with reference with FIGS. 1 and 2, the bottom walls 14.1 and 14.2 of the parts 4.1 and 4.2 of the tray 4 shows stiffening ribs 22 which mate with each other between the two parts 4.1 and 4.2. For instance, the bottom walls 14.1 and 14.2 comprise each two longitudinal ribs 22. The ribs 22 show for instance a triangular cross-section, being however understood that other shapes can also be considered. The ribs 22 extend along the whole length of the bottom walls 14.1 and 14.2 in order to allow relative sliding movement between the parts 4.1 and 4.2 along their whole lengths, or at least along nearly their whole lengths.

The stand 6 is designed for supporting the tray 4, i.e, for receiving the lower face of the bottom walls 14.1 and 14.2. To that end the stand 6 shows legs and a support portion where the support portion is distant from the lower ends of the legs. For instance, the stand 6 is made of metal wire. It comprises for instance four vertical wires 6.1 forming the legs, and horizontal wires 6.2 interconnecting the vertical wires 6.1. These wires are welded or soldered together at their mutual contact areas. In the present embodiment, the stand 6 comprises four horizontal wires 6.2, i.e. two lower wires extending longitudinally and two upper wires extending transversally. The horizontal wires 6.2 form the support portion. The lower horizontal wires 6.2 are positioned relative to each other so that they are in contact with the bottom walls 14.1 and 14.2. The two upper horizontal wires 6.2 are perpendicular to the two lower horizontal wires 6.2 and contact shoulder portions 10a.1 and 10a.2 of the lateral side walls 10.1 and 10.2.

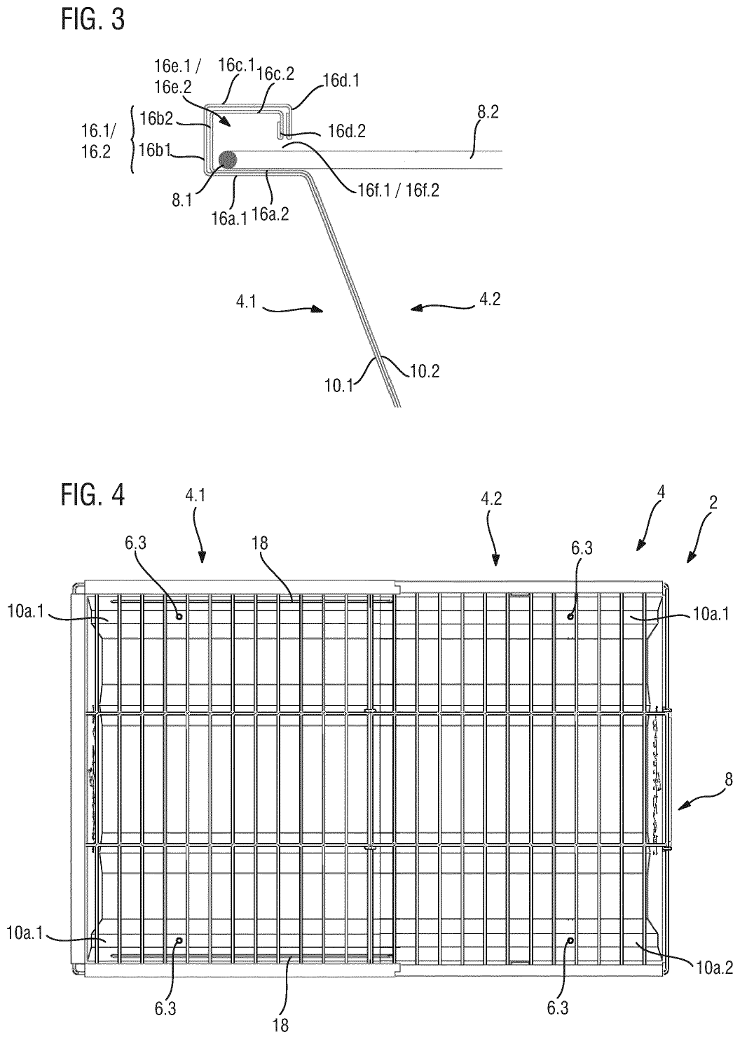

FIG. 3 is a sectional view of the distal edges 16.1 and 16.2 of the lateral side walls 10.1 and 10.2 on one lateral side of the tray 4. More specifically, FIG. 3 illustrates the shape of the longitudinal distal edges 16.1 and 16.2 and their engagement relative to each other and their engagement with the cooking grate 8. We can observe each rail-shaped distal edge comprises, successively when going along the wall 10.1/10.2 towards the terminal end of said wall, a first horizontal section 16a.1/16a.2 adjacent the lateral side wall 10.1/10.2, a first vertical section 16b.1/16b.2, a second horizontal section 16c.1/16c.2 and a second vertical section 16d.1/16d.2 with a distal end distant from the first horizontal section 16a.1/16a.2 so as to form an opening 16f.1/16f.2 of the cavity 16e1/16e.2. As is apparent in FIG. 3, the corresponding longitudinal edge of the cooking grate 8 extends inside the cavity 16e1/16e.2 through the opening 16f.1/16f.2.

FIG. 4 is a top view of the barbecue of FIGS. 1 and 2. As readily apparent in FIG. 1, we can observe that the stand 6 comprises four pins 6.3 protruding upwardly through corresponding openings formed in the shoulder portions 10a.1 and 10a.2 of the lateral side walls 10.1 and 10.2. These pins 6.3 are advantageously the end portions of the four vertical wires 6.1 (FIGS. 1 and 2). This engagement between the stand 6 and the tray 4 provides a proper relative positioning which is beneficial for a comfortable and safe use of the barbecue. This means for example that when the barbecue is place on a surface which shows a slight slope, e.g. on the ground or a table, during use of the barbecue, the tray will not slide away from the stand and fall in an uncontrolled manner. The same applies even when the barbecue is placed on a perfectly even and horizontal surface, e.g. when manipulating pieces of meat that might slightly stick to the cooking grate 8. The diameter of the openings formed in the shoulder portions 10a.1 and 10a.2 of the lateral side walls 10.1 and 10.2 shows a limited play with the diameter of the pins 6.3, e.g. less than 50%, preferably less than 20%, of the diameter of the pins 6.3.

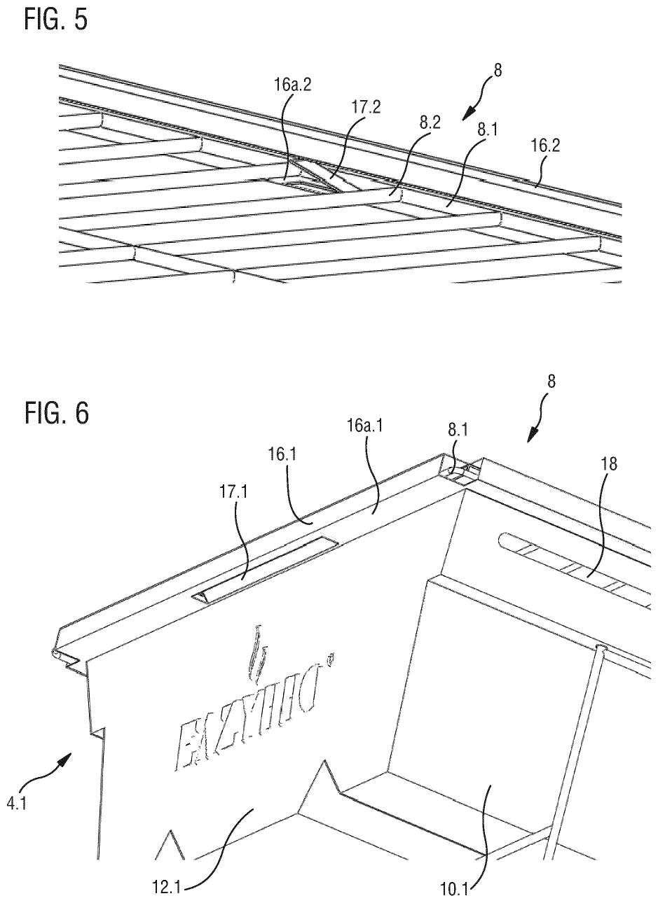

FIG. 5 is a detailed perspective view of the tab 17.2 in the distal edge 16.2 of the lateral side wall of the part 4.2 of the tray 4, cooperating with the cooking grate 8. As is apparent, the tab 17.2 is integrally formed by cutting according to a U-profile the support surface 16a.2 of the distal edge 16.2. The tab 17.2 is bent so as to be inclined relative to the support surface 16a.2 for bending back towards said surface when the cooking grate 8 is inserted and for engaging with the said grate when it is attempted to remove said grate. For instance, the tab 17.2 is contacted by the transversal wires 8.2 of the grate 8 when the latter is inserted.

FIG. 6 is a detailed perspective view of the distal edge 16.1 of the end side wall 12.1 of the part 4.1 of the tray 4, showing the tab 17.1. The latter is advantageously integrally formed by cutting in the support surface 16a.1 of the distal edge 16.1. The tab 17.1 is bent so as to be inclined relative to the support surface 16a.1 for bending back towards said surface when the cooking grate 8 is inserted and for engaging with the said grate when it is attempted to remove said grate. For instance, the tab 17.1 is contacted by the contour wire 8.1 of the grate 8 when the latter is inserted.

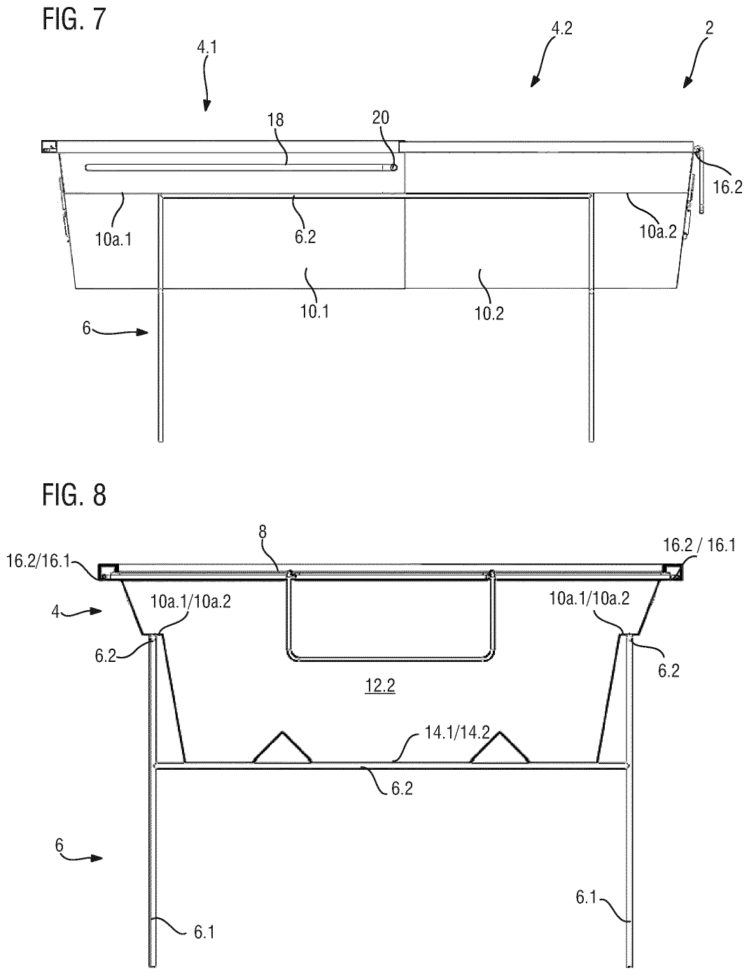

FIG. 7 is a lateral side view of the barbecue of FIGS. 1 to 6, where the slot 18 and the corresponding bossing or pin 20 in the lateral side walls 10.1 and 10.2, respectively, are well visible.

With reference to FIGS. 1, 4 and 7, we can observe that the transversal distal edge 16.2 of the part 4.2 of the tray 4 is aligned with the supporting surface formed by the first horizontal section 16a.1 and 16a.2 of the longitudinal distal edges 16.1 and 16.2 (see FIG. 3), in order to form a slot or passage for insertion of the cooking grate 8. Optionally, that edge can then be manually folded upwardly after insertion of the cooking grate 8, thereby preventing said grate to slide out of the rails of the distal edges.

FIG. 8 is a front view of the barbecue of FIGS. 1 to 7. We can observe that the lower horizontal wires 6.2 contact the bottom walls 14.1 and 14.2 of the tray 4 whereas the upper horizontal wires 6.2 contact the shoulder portions 10a.1 and 10a.2 of the lateral side walls 10.1 and 10.2.

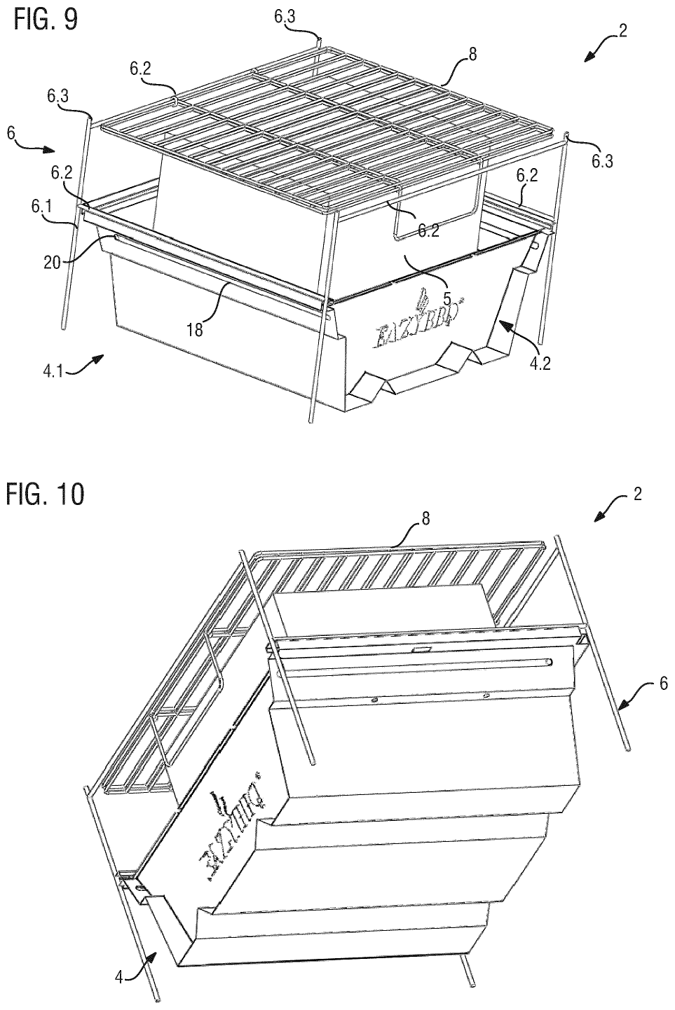

FIGS. 9 and 10 illustrate the barbecue of FIGS. 1 to 6 in a collapsed state ready for being packaged. We can observe that the part 4.2 is slid totally or nearly totally inside the part 4.1, i.e. up to a point where the bossing or pin 20 reaches the opposite end of the slot 18, A packaged charcoal unit 5 is placed in the reduced cavity of the tray in that collapsed state. The cooking grate 8 is made of two parts, each corresponding at least approximately to a half thereof. Both parts are superimposed and placed on the top face of the package of the charcoal 5. The stand 6 is rotated by 90° relative to the position in use as illustrated in FIGS. 1, 2, 7 and 8. This is apparent in that the upper horizontal wires 6.2 extend transversally to the extension direction of the tray whereas in use this is the contrary. Similarly, the lower horizontal wires 6.2 extend longitudinally along the extension direction of the tray whereas in use this is the contrary.

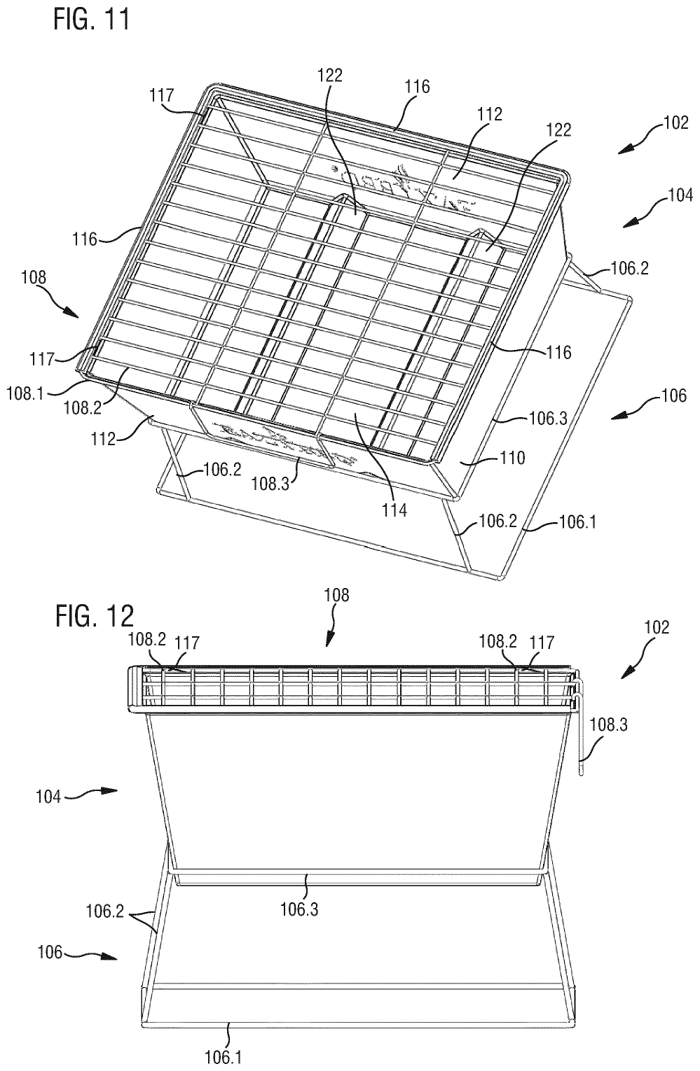

FIGS. 11 to 14 illustrate a barbecue according to another example not being part of the invention. The reference numbers in FIGS. 1-10 are used here for designating the same or corresponding elements where however these numbers are incremented by 100. It is also referred to the description of these elements in relation with FIGS. 1-10.

FIGS. 11 and 12 are top and side perspective views of the barbecue.

With reference to FIG. 11, similarly to the barbecue of FIGS. 1-10, the barbecue 102 comprises essentially a tray 104, a stand 106 and a cooking grate 108. The tray 104 is made of metallic foil, preferably of aluminium foil. The foil can have a thickness of less than 0.5 mm, preferably less than 0.2 mm, more preferably less than 0.1 mm. As is apparent in FIG. 1, the tray 104 comprises a bottom wall 114 and side walls 110 and 112 forming a cavity for receiving charcoal or wood or any other combustible material that is adapted for cooking food. The tray shows advantageously a generally rectangular form where the side walls need not be perpendicular to the bottom wall, i.e. slightly widen from the bottom to the opening of the cavity.

The side edges 116 of the side walls 110 and 112, more particularly of the two lateral side walls 110 and of one of the end side wall 112, form each a rail with an opening for receiving a corresponding edge of the cooking grate 108. Similarly to the embodiment of FIGS. 1 to 10, the railed-shaped distal edges 116 can comprise means for retaining the cooking grate 108. More specifically, these means can be tabs 117 which are preferably integrally formed in the support surface of the cooking grate 108, e.g. by cutting a U-shaped portion of said surface and bending said portion out of the support surface. The tab 117 is bent so as to be inclined relative to the support surface for bending back towards said surface when the cooking grate 108 is inserted and for engaging with the said grate when it is attempted to remove said grate. The tabs 117 are advantageously formed in the two rail-shaped distal edges 116 of the lateral side walls 110. Advantageously, the distal edge 116 of each of the two lateral side walls 110 comprises at least two tabs 117.

With reference to FIGS. 11 and 12, we observe that the stand 106 is generally made of wires welded to each other. It comprises a base portion 106.1 forming a lower frame intended to contact a support surface. The stand 106 comprises also wires 106.2 extending upwardly from the base 106.1 and connecting to an upper receiving frame 106.3 that receives the tray 104. More specifically, the upper frame shows a shape that is similar to the contour of the tray, for instance a rectangular shape. The upper frame 106.3 is dimensioned larger than the base 114 of the tray 104 so as to be able to receive said tray. Advantageously, the side walls 110 and 112 of the tray 104 widen from the bottom wall to the opening of the cavity, so that said walls contact the upper frame 106.3 when the tray 104 is placed on the stand 106.

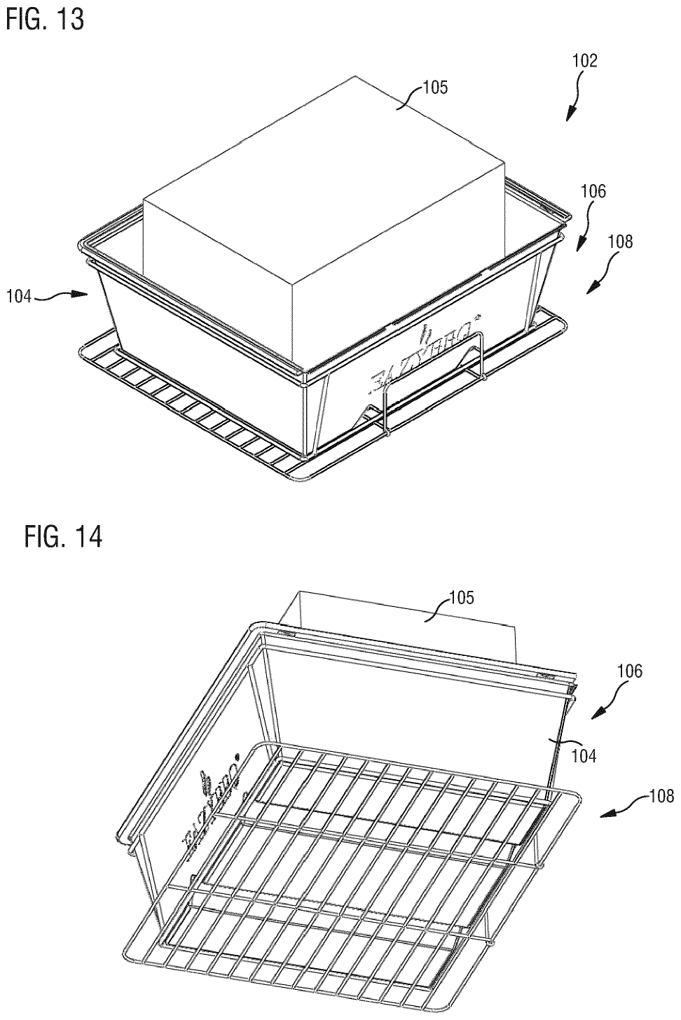

FIGS. 13 and 14 are top and low perspective views of the barbecue of FIGS. 11 and 12, in packaged state. As apparent in these figures, the stand 106 is configured such that when rotated upside down fits around the tray 104 for reducing the packaged volume. The cooking grate 108 can be placed under the tray 104 and the stand 106. A packaged charcoal unit 105 can be placed in the cavity of the tray 104.

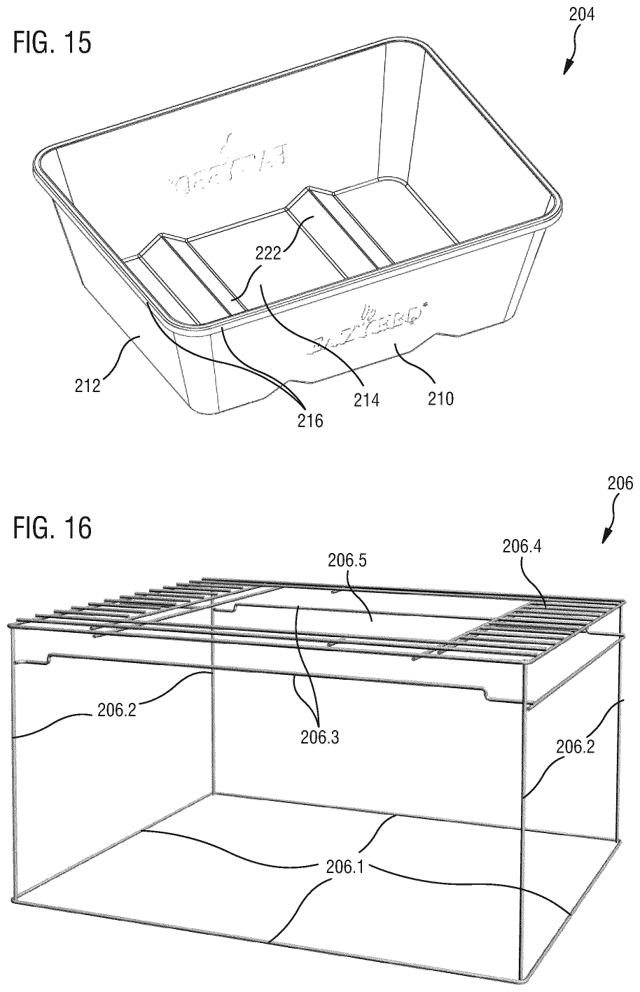

FIGS. 15 to 19 illustrate different elements of a barbecue according to a first embodiment of the invention. The reference numbers in FIGS. 1-10 are used here for designating the same or corresponding elements where however these numbers are incremented by 200. It is also referred to the description of these elements in relation with FIGS. 1-10 and also with FIGS. 11-14.

FIG. 15 is a perspective view of the tray 204 of the barbecue according the first embodiment. The tray 204 is preferably made of metal, e.g. aluminium foil. It is advantageously rectangular with two lateral side walls 210, two end side wall 212, and a bottom wall 214. These walls form a cavity opening upwardly and designed for receiving fuel like charcoal, in particular a fuel unit as illustrated in FIGS. 13 and 14 relating to another example (reference 105). Such fuels units are commercial available. They show a cuboid form and comprise a central chimney made of light combustible material like cardboard, charcoal, firing starting material like straw, and outer packaging made also light combustible material like cardboard.

The side walls 210 and 212, in particular the lateral side walls 210, show lateral shoulder edges 216. These can form lateral flanges extending essentially parallel to the bottom wall.

The bottom wall 214 show stiffening ribs 222 which for instance extend transversally. The ribs 222 show for instance a triangular cross-section, being however understood that other shapes can also be considered. The ribs 222 extend along the whole lateral length of the bottom wall.

FIG. 16 is a perspective view of a stand 206 of the barbecue according the first embodiment. The stand 206 is made predominantly, preferably exclusively, of metal wires joined to each other by welding. It comprises a base portion 206.1 forming a lower frame intended to contact a support surface. The stand 206 comprises also wires 206.2 extending upwardly from the base 206.1 and connecting to a lower support surfaces 206.3 that receive the tray 204. More specifically, the lower support surfaces 206.3 comprise two elongate parallel steel wires specially configured for supporting the shoulder edges 216 of the lateral side walls 210 of the tray 204. As this is apparent, each elongate steel wire 206.3 can comprises a central main portion that is raised relative to lateral end portions. The vertical wires 206.2 connect also to an upper frame 206.4 locate above the lower support surfaces 206.3 for the tray. The upper frame 206.4 shows a central hole 206.5 intended to allow insertion of the above mentioned fuel unit. As this is apparent the upper frame 206.4 can comprise a fixed grate area adjacent the hole 206.5, in particular surrounding the hole 206.5.

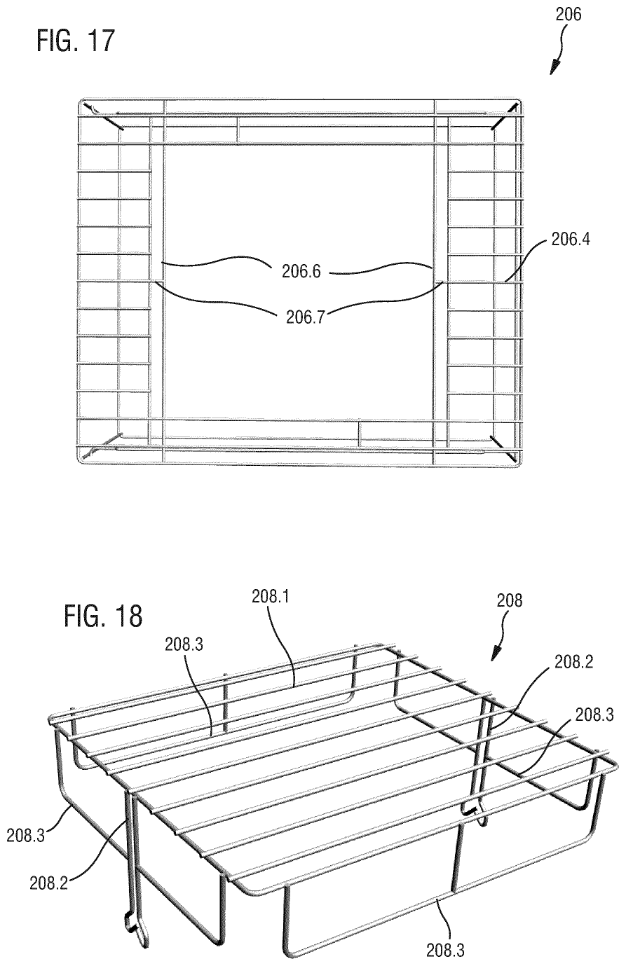

FIG. 17 is a top view of the stand 206 of FIG. 16. The upper frame 206.4 with the fixed grate area, and the hole 206.5 are well visible. We can also observe that the hole 206.5 is delimited at two opposed sides by the steel wires 206.6 forming upper support surfaces for a cooking grate (illustrated in FIG. 18). The upper frame 206.4 comprises also two anchoring steel wire portions 206.7 that connect perpendicularly to the steel wires 206.6 forming the upper support surfaces.

FIG. 18 is a perspective view of a cooking grate 208 of the barbecue according the first embodiment. The cooking grate, similarly to the stand, is made predominantly, preferably exclusively, of metal wires joined to each other by welding. It comprises a main flat portion 208.1 formed for instance by a rectangular wire and a series of transversal wires welded at each end thereof to the rectangular wire. The cooking grate 208 comprises also two guiding elements 208.2 extending perpendicularly to the main portion 208.1 from opposed edges of said portion. These guiding elements 208.2 are configured for engaging with the stand 206, more particularly with the upper frame 206.4 thereof (FIGS. 16 and 17), even more particularly with the anchoring wire portions 206.7 thereof (FIG. 17), in order to anchor the cooking grate 208 to the stand, in a raised position, and also to allow a progressive lowering movement of the cooing grate 208 until it rests on the upper support surfaces 206.6 of the stand 206.

More specifically, each guiding element 208.2 can be made of two parallel steel wire extending perpendicularly from the main portion 208.1 and ending respectively with curved portions and distal ends that contact each other, in order to form a converging end lateral provide to engage with the anchoring wire portions 206.7 (FIG. 17) when lowering the cooking grate 208 towards the stand 206 (FIG. 17).

The cooking grate can also comprise U-shaped steel wires 208.3 extending perpendicularly to the main portion 208.1 from side edges of said portion, so as to form a lateral retaining surfaces relative to the cuboid fuel unit.

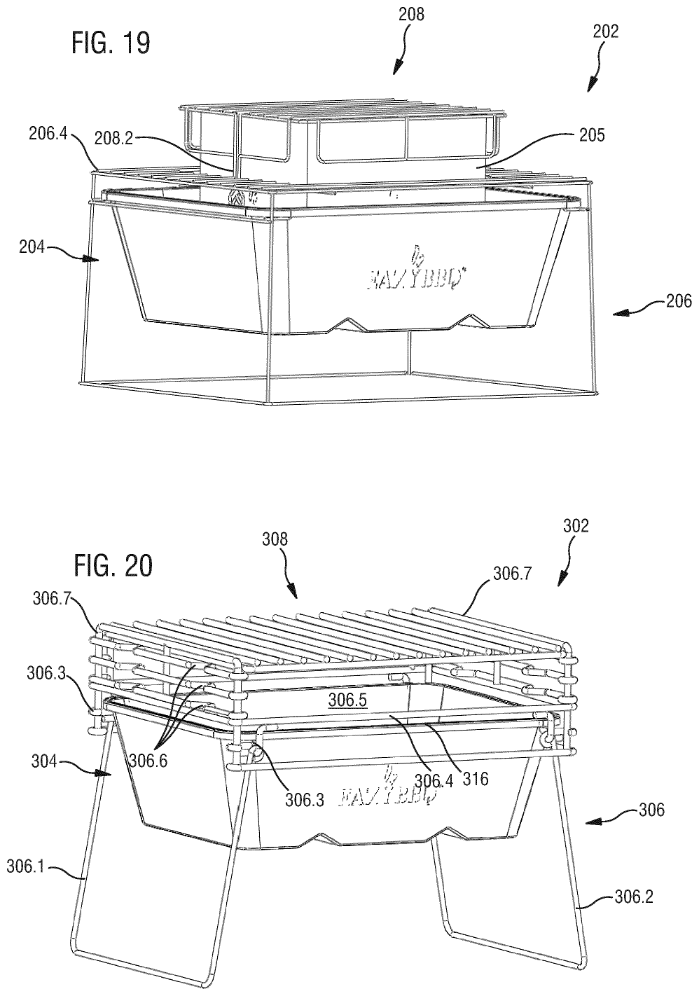

FIG. 19 is a perspective view of the barbecue 202 according to the first embodiment of the invention, i.e. comprising the tray of FIG. 15, the stand of FIGS. 16 and 17, and the cooking grate of FIG. 18. We can observe that cooking grate in the raised position while the guiding elements 208.2 are in engagement with the stand 206, more specifically with the upper frame 206.4 thereof. Once the cuboid fuel unit 205 starts to lower in height due to the combustion, the cooking grate 208 progressively moves down toward the upper frame 206.4 of the stand 206.

FIG. 20 is a perspective view of a barbecue according to a second embodiment of the invention. The reference numbers in FIGS. 15-19 are used here for designating the same or corresponding elements where however these numbers are incremented by 100. It is also referred to the description of these elements in relation with FIGS. 15-19.

The barbecue 302 comprises, like the one of the first embodiment, a tray 304, a stand 306 and a cooking grate 308. The tray 304 is similar to the tray 204 of FIG. 15. It can also be identical. The stand 306 and the cooking grate 308 are however different. The stand 306 is of the foldable type, i.e. comprises a main frame 306.4 forming the opening 306.5 and with two legs 306.1 and 306.2 pivotally mounted on said frame. The stand 306 comprises also two side walls 306.7 pivotally mounted the frame 306.4 and comprising discrete upper support surfaces 306.6 for the cooking grate 308. The cooking grate 308 is therefore slid or inserted horizontally between the two side walls 306.7 and along the upper support surfaces 306.6.

1.-16. (canceled)

17. A barbecue, comprising:
a tray forming a cavity for containing a fuel unit like charcoal;
a cooking grate; and
a stand for operatively holding the tray and the cooking grate relative to each other;
wherein the tray is rectangular and comprises two parallel lateral shoulder edges; and
wherein the stand comprises:
lower support surfaces for said lateral shoulder edges, the support surfaces being configured for allowing the tray to be slid along said support surfaces, and
upper support surfaces for the cooking grate.

18. The barbecue according to claim 17, wherein at least one of the cooking grate and the upper support surfaces is configured for providing a variable position in height of said grate.

19. The barbecue according to claim 17, wherein the stand is exclusively made of steel wires attached to each other so as to form a tri-dimensional structure.

20. The barbecue according to claim 17, wherein the lower support surfaces are made of two parallel streel wires.

21. The barbecue according to claim 20, wherein each of the two parallel streel wires comprises:
a central main portion that is raised relative to two lateral end portions.

22. The barbecue according to claim 20, wherein the two parallel lateral shoulder edges form two elongate flanges that can be folded by hand around the two parallel streel wires once said tray is slid in position along said two parallel streel wires.

23. The barbecue according to claim 17, wherein the stand comprises:
a central passage through which a cuboid fuel unit can be placed while the cooking grate rests on a top of said unit.

24. The barbecue according to claim 23, wherein the cooking grate comprises:
a main portion forming the grate; and
at least two guiding elements extending perpendicularly to the main portion and configured for cooperating with the stand and guiding the cooking grate from a raised position to a lower position where said grate rests on the upper support surfaces of the stand.

25. The barbecue according to claim 24, wherein each of the at least two guiding elements is configured for engaging with the stand when the cooking grate is in the raised position so as to prevent removal thereof.

26. The barbecue according to claim 24, wherein each of the at least two guiding elements comprises:
two parallel steel wires terminating with rounded portions and distal ends that contact each other so as to form a distal converging profile that can engage with a corresponding anchoring wire portion of the stand by pressing the cooking grate downwardly.

27. The barbecue according to claim 26, wherein the upper support surfaces of the stand are formed by steel wires joined perpendicularly to the anchoring wire portions.

28. The barbecue according to claim 23, wherein the cooking grate further comprises:
U-shaped steel wires extending form each side edge of the main portion, perpendicularly to said portion, so as to form lateral retaining surfaces relative to the cuboid fuel unit.

29. The barbecue according to claim 17, wherein the upper support surfaces of the stand provide several discrete positions in height for the cooking grate.

30. The barbecue according to claim 17, wherein the stand comprises:
a central frame;
two side walls with the upper support surfaces; and
at least two legs, said side walls and legs being foldable relative to the central frame.

31. The barbecue according to claim 17, wherein the tray comprises:
a bottom wall with elements forming a raised support surface for the fuel unit, configured for allowing an air circulation between said unit and said bottom wall.

32. The barbecue according to claim 31, wherein the elements of the bottom wall comprise:
at least two stiffening ribs extending parallel to each other and projecting towards an opening of the cavity.
